(19) United States
(12) Patent Application Publication
(10) Pub. No.: US 2009/0309821 A1
(43) Pub. Date: Dec. 17, 2009

(54) Display Device

(75) Inventor: Junji Tanno, Chiba (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Displays, Ltd.

(21) Appl. No.: 12/482,484

(22) Filed: Jun. 11, 2009

(30) Foreign Application Priority Data
Jun. 13, 2008 (JP) 2008-155393

(51) Int. Cl. G09G 3/36

(52) U.S. Cl. 345/87

(57) ABSTRACT

Each of a plurality of pixels is composed of a first sub-pixel for a first color, a second sub-pixel for a second color, and a third sub-pixel for a third color. The longitudinal direction of the first sub-pixel is the extending direction of video lines, and the longitudinal direction of each of the second sub-pixel and the third sub-pixel is the extending direction of scanning lines. The second sub-pixel and the third sub-pixel are arranged adjacent to each other on one side of the first sub-pixel. The first sub-pixels are continuously formed in two adjacent pixels in the extending direction of the video lines. When three adjacent pixels in the extending direction of the video lines are defined as first to third pixels, the second sub-pixels are continuously formed in the first pixel and the second pixel, and the third sub-pixels are continuously formed in the second pixel and the third pixel.

### CROSS REFERENCE TO RELATED APPLICATION

The present application claims priority from Japanese application JP 2008-155393 filed on Jun. 13, 2008, the content of which is hereby incorporated by reference into this application.

### BACKGROUND OF THE INVENTION

1. Field of the Invention

The present invention relates to a display device and a liquid crystal display device, and more particularly to a technology effectively applied to a display device for color display in which each of a plurality of pixels is composed of sub-pixels of three colors.

2. Background Art

As a display device for color display, for example, a liquid crystal display device has been known.

The liquid crystal display device includes color filters for performing color display irrespective of a display method. Colors used for the color filters are basically three primary colors (RGB) of red (R), green (G), and blue (B), and red, green, and blue constitute one basic unit (one pixel).

Examples of related art document relevant to the invention include JP-A-2005-62220 and JP-A-8-335060.

In the liquid crystal display device, a light-shielding film such as a black matrix is usually disposed between sub-pixels to avoid color mixture of red, green, and blue. The light-shielding film is disposed mainly because of the following reasons:

(1) In a manufacturing step of color filters, the black matrix is first formed by a photolithography method, and thereafter, color resists are formed by a photolithography method in the same manner in the order of red, green, and blue. In that case, a gap between colors or the superposition of colors is generated due to misalignment in the respective photolithography steps of red, green, and blue, and the black matrix is formed considering the manufacturing margin to prevent the appearance of the gap between colors or the superposition of colors on a display.

(2) Misalignment occurs when a TFT substrate (array substrate) and a CF substrate (color filter substrate) overlap with each other. A different color sometimes appears in an adjacent sub-pixel when the misalignment is large, and the black matrix is formed considering the manufacturing margin to prevent the appearance of the different color on a display.

If the light-shielding film is not disposed, color mixture occurs between sub-pixels of different colors due to the misalignment in the manufacturing step, leading to a remarkable reduction in display quality such as a reduction in color reproducibility. However, when the light-shielding film is disposed between sub-pixels to prevent color mixture, there arise a drawback that the aperture ratio is reduced.

The influence is small when the size of a pixel is large. However, as the size of a pixel becomes smaller with higher definition, the ratio of an area occupied by the light-shielding film in sub-pixels becomes larger, reducing the aperture ratio. When the aperture ratio is reduced, display luminance is reduced, thereby remarkably reducing the display quality. While, when the brightness of a backlight is increased to maintain the display luminance, there arises a drawback that the power consumption is increased.

### SUMMARY OF THE INVENTION

The invention has been made to overcome the drawbacks in the related art, and it is an object of the invention to provide a technology capable of improving the aperture ratio of a display device.

The above and other objects of the invention and the novel features thereof will be apparent from the description of the specification and the accompanying drawings.

A display device of the invention includes a plurality of pixels arranged in a matrix, a plurality of scanning lines extending in a first direction and arranged in parallel in a second direction crossing the first direction, and a plurality of video lines extending in the second direction while crossing the scanning lines and arranged in parallel in the first direction. Each of the plurality of pixels is composed of a first sub-pixel for a first color, a second sub-pixel for a second color, and a third sub-pixel for a third color. The longitudinal direction of the first sub-pixel is the extending direction of the video lines. The longitudinal direction of each of the second sub-pixel and the third sub-pixel is the extending direction of the scanning lines. The second sub-pixel and the third sub-pixel are arranged adjacent to each other on one side of the first sub-pixel and side by side in the extending direction of the video lines. The first sub-pixels are continuously formed in two adjacent pixels in the extending direction of the video lines. When three adjacent pixels in the extending direction of the video lines are defined as first to third pixels, the second sub-pixels are continuously formed in the first pixel and the second pixel, and the third sub-pixels are continuously formed in the second pixel and the third pixel.

Further, a display device having other features of the invention includes a liquid crystal display panel having a first substrate, a second substrate, and a liquid crystal layer interposed between the first substrate and the second substrate. The liquid crystal display panel has a plurality of pixels arranged in a matrix, a plurality of scanning lines extending in a first direction and arranged in parallel in a second direction crossing the first direction, and a plurality of video lines extending in the second direction while crossing the scanning lines and arranged in parallel in the first direction. Each of the plurality of pixels is composed of a first sub-pixel having a color filter for a first color, a second sub-pixel having a color filter for a second color, and a third sub-pixel having a color filter for a third color. Each of the first sub-pixel, the second sub-pixel, and the third sub-pixel has a pixel electrode formed above the first substrate and a counter electrode formed above the first substrate. The longitudinal direction of the first sub-pixel is the extending direction of the video lines, and the longitudinal direction of each of the second sub-pixel and the third sub-pixel is the extending direction of the scanning lines. The second sub-pixel and the third sub-pixel are arranged adjacent to each other on one side of the first sub-pixel and side by side in the extending direction of the video lines. The first sub-pixels are continuously formed in two adjacent pixels in the extending direction of the video lines. When three adjacent pixels in the extending direction of the video lines are defined as first to third pixels, the second sub-pixels are continuously formed in the first pixel and the second pixel, and the third sub-pixels are continuously formed in the second pixel and the third pixel.

### BRIEF DESCRIPTION OF THE DRAWINGS

FIG. 1 is a plan view showing an arrangement of color filters of a liquid crystal display panel in a fully transmissive liquid crystal display device of an IFPS type of a first embodiment of the invention;

FIG. 2 is a partially enlarged plan view of FIG. 1;

FIG. 3 is a plan view showing a pixel configuration of FIG. 2 in a simplified manner;

FIG. 4 is a plan view showing pixel electrodes and a counter electrode on a TFT substrate side of the liquid crystal display panel of the first embodiment of the invention;

FIG. 5 is a plan view showing pixel electrodes, a scanning line, and video lines on the TFT substrate side of the liquid crystal display panel of the first embodiment of the invention;

FIG. 6 is a cross sectional view showing a cross sectional structure of the liquid crystal display panel of the first embodiment of the invention taken along line A-A′ in FIG. 5;

FIG. 7 is a cross sectional view showing a cross sectional structure of the liquid crystal display panel of the first embodiment of the invention taken along line B-B′ in FIG. 5;

FIG. 8 is a plan view showing an arrangement of color filters of a liquid crystal display panel in a fully transmissive liquid crystal display device of the IPS type of a second embodiment of the invention;

FIG. 9 is a plan view showing pixel electrodes, a scanning line, and video lines on a TFT substrate side of a liquid crystal display panel in a fully transmissive liquid crystal display device of the IPS type of a third embodiment of the invention;

FIG. 10 is a plan view showing pixel electrodes, a scanning line, and video lines on a TFT substrate side of a liquid crystal display panel in a fully transmissive liquid crystal display device of the IPS type of a fourth embodiment of the invention;

FIG. 11 is a plan view showing pixel electrodes, a scanning line, and video lines on a TFT substrate side of a liquid crystal display panel in a fully transmissive liquid crystal display device of the IPS type of a fifth embodiment of the invention; and

FIG. 12 is a plan view showing electrodes and wiring in one pixel in an organic electroluminescent display device of a sixth embodiment of the invention.

### DESCRIPTION OF THE PREFERRED EMBODIMENTS

Typical outlines of the invention disclosed herein will be briefly described below.

(1) A display device includes a plurality of pixels arranged in a matrix, a plurality of scanning lines extending in a first direction and arranged in parallel in a second direction crossing the first direction, and a plurality of video lines extending in the second direction while crossing the scanning lines and arranged in parallel in the first direction. Each of the plurality of pixels is composed of a first sub-pixel for a first color, a second sub-pixel for a second color, and a third sub-pixel for a third color. The longitudinal direction of the first sub-pixel is the extending direction of the video lines (Y-direction), and the longitudinal direction of each of the second sub-pixel and the third sub-pixel is the extending direction of the scanning lines (X-direction). The second sub-pixel and the third sub-pixel are arranged adjacent to each other on one side of the first sub-pixel and side by side in the extending direction of the video lines. The first sub-pixels are continuously formed in two adjacent pixels in the extending direction of the video lines. When three adjacent pixels in the extending direction of the video lines are defined as first to third pixels, the second sub-pixels are continuously formed in the first pixel and the second pixel, and the third sub-pixels are continuously formed in the second pixel and the third pixel.

(2) In the above (1), the display device further includes a light-shielding film between the second sub-pixel and the third sub-pixel.

(3) In the above (2), the light-shielding film is formed so as to cross the first sub-pixel.

(4) In the above (1), when two adjacent pixels in the extending direction of the scanning lines are respectively defined as one pixel and the other pixel, the second sub-pixel and the third sub-pixel are arranged adjacent to each other in the extending direction of the video lines on one side of the first sub-pixel in the order of the second sub-pixel and the third sub-pixel in the one pixel, and the second sub-pixel and the third sub-pixel are arranged adjacent to each other in the extending direction of the video lines on one side of the first sub-pixel in the order of the third sub-pixel and the second sub-pixel in the other pixel.

(5) In the above (1), a video line for any one of the second sub-pixel and the third sub-pixel and a video line for the first sub-pixel among the plurality of video lines are arranged close to each other.

(6) In the above (1), the display device is a liquid crystal display device including a liquid crystal display panel having the plurality of pixels, the plurality of scanning lines, and the plurality of video lines.

(7) In the above (6), the liquid crystal display device has a normally black characteristic.

(8) In the above (6), the liquid crystal display device is a liquid crystal display device of a vertical electric field type.

(9) In the above (6), the liquid crystal display device is a liquid crystal display device of a lateral electric field type.

(10) A liquid crystal display device includes a liquid crystal display panel having a first substrate, a second substrate, and a liquid crystal layer interposed between the first substrate and the second substrate. The liquid crystal display panel has a plurality of pixels arranged in a matrix, a plurality of scanning lines extending in a first direction and arranged in parallel in a second direction crossing the first direction, and a plurality of video lines extending in the second direction while crossing the scanning lines and arranged in parallel in the first direction. Each of the plurality of pixels is composed of a first sub-pixel having a color filter for a first color, a second sub-pixel having a color filter for a second color, and a third sub-pixel having a color filter for a third color. Each of the first sub-pixel, the second sub-pixel, and the third sub-pixel has a pixel electrode formed above the first substrate and a counter electrode formed above the first substrate. The longitudinal direction of the first sub-pixel is the extending direction of the video lines (Y-direction), and the longitudinal direction of each of the second sub-pixel and the third sub-pixel is the extending direction of the scanning lines (X-direction). The second sub-pixel and the third sub-pixel are arranged adjacent to each other on one side of the first sub-pixel and side by side in the extending direction of the video lines. The first sub-pixels are continuously formed in two adjacent pixels in the extending direction of the video lines. When three adjacent pixels in the extending direction of the video lines are defined as first to third pixels, the second sub-pixels are continuously formed in the first pixel and the second pixel, and the third sub-pixels are continuously formed in the second pixel and the third pixel.

(11) In the above (10), each of the pixel electrodes of the first sub-pixel, the second sub-pixel, and the third sub-pixel has a single-domain structure with a plurality of linear portions extending along the extending direction of the scanning lines and arranged in parallel in the extending direction of the video lines.

(12) In the above (10), each of the pixel electrodes of the first sub-pixel, the second sub-pixel, and the third sub-pixel has a multi-domain structure with a plurality of first linear portions extending at an angle of θ with respect to the video lines and arranged in parallel in the extending direction of the video lines, and a plurality of second linear portions extending at an angle of −θ with respect to the video lines and arranged in parallel in the extending direction of the video lines.

(13) In the above (10), an AC driving method of the liquid crystal display device is a frame inversion driving method.

(14) In the above (10), the liquid crystal display device further includes a light-shielding film between the second sub-pixel and the third sub-pixel.

(15) In the above (14), the light-shielding film is formed so as to cross the first sub-pixel.

(16) In the above (10), when two adjacent pixels in the extending direction of the scanning lines are respectively defined as one pixel and the other pixel, the second sub-pixel and the third sub-pixel are arranged adjacent to each other in the extending direction of the video lines on one side of the first sub-pixel in the order of the second sub-pixel and the third sub-pixel in the one pixel, and the second sub-pixel and the third sub-pixel are arranged adjacent to each other in the extending direction of the video lines on one side of the first sub-pixel in the order of the third sub-pixel and the second sub-pixel in the other pixel.

(17) In the above (10), the pixel electrode and the counter electrode are stacked together via an insulating film. Hereinafter, embodiments of the invention will be described in detail with reference to the drawings. Throughout the drawings for explaining the embodiments of the invention, elements having the same function are denoted by the same reference numerals and signs, and the repetitive description thereof is omitted.

As a display device, an active matrix type liquid crystal display device has been known. The display method of the active matrix type liquid crystal display device can be classified into a vertical electric field type and a lateral electric field (IPS: In-Plane-Switching) type. In the embodiment, an example in which the invention is applied to the active matrix type liquid crystal display device of the IPS type will be described.

Here, a minimum unit for displaying a letter or a graphic is referred to as a dot, and the dot of the minimum unit is referred to as a pixel in a liquid crystal display.

In color display, a pixel is divided into portions of three colors of red (R), green (G), and blue (B), and therefore, the portions of RGB three colors are collectively referred to as a pixel, while one-third (⅓) dot divided based on RGB is referred to as a sub-pixel. Cyan, magenta, and yellow may be used instead of RGB.

### First Embodiment

In a first embodiment, an example in which the invention is applied to a fully transmissive liquid crystal display device of the IPS type will be described.

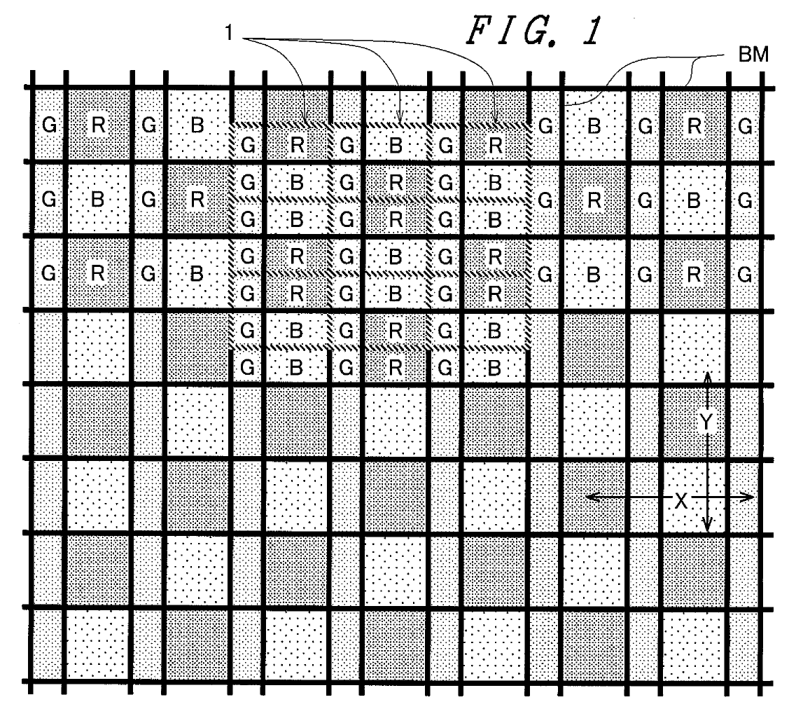

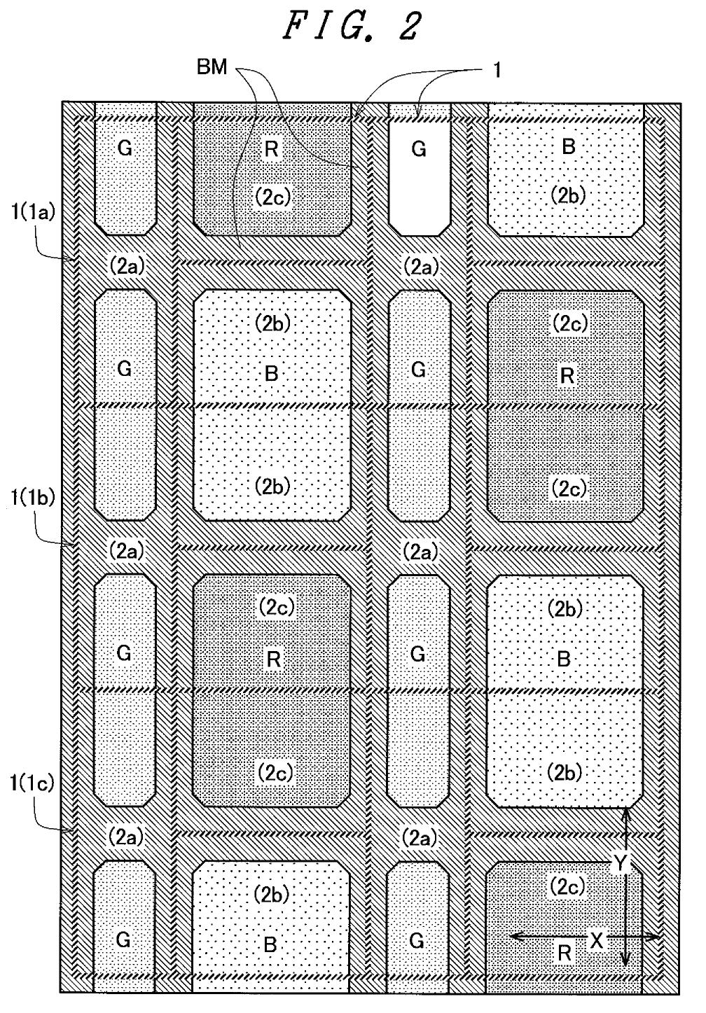

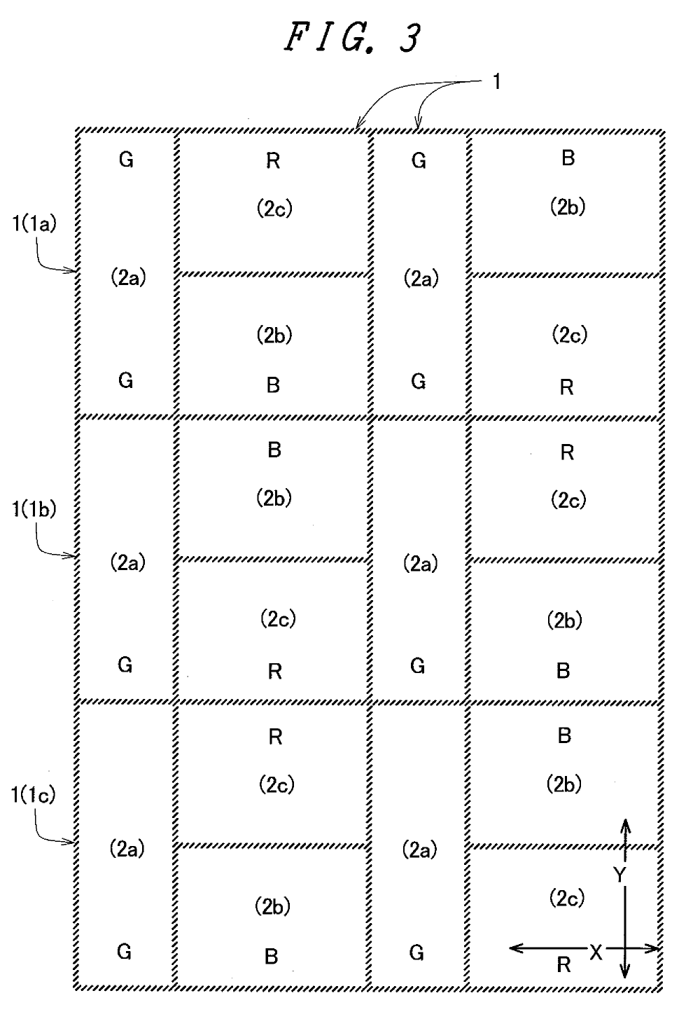

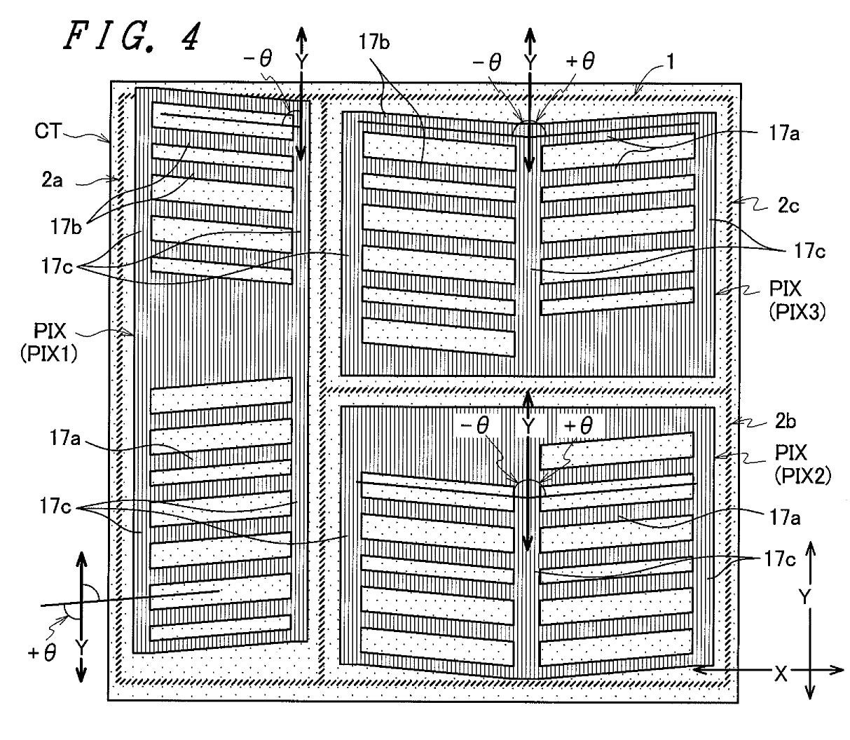

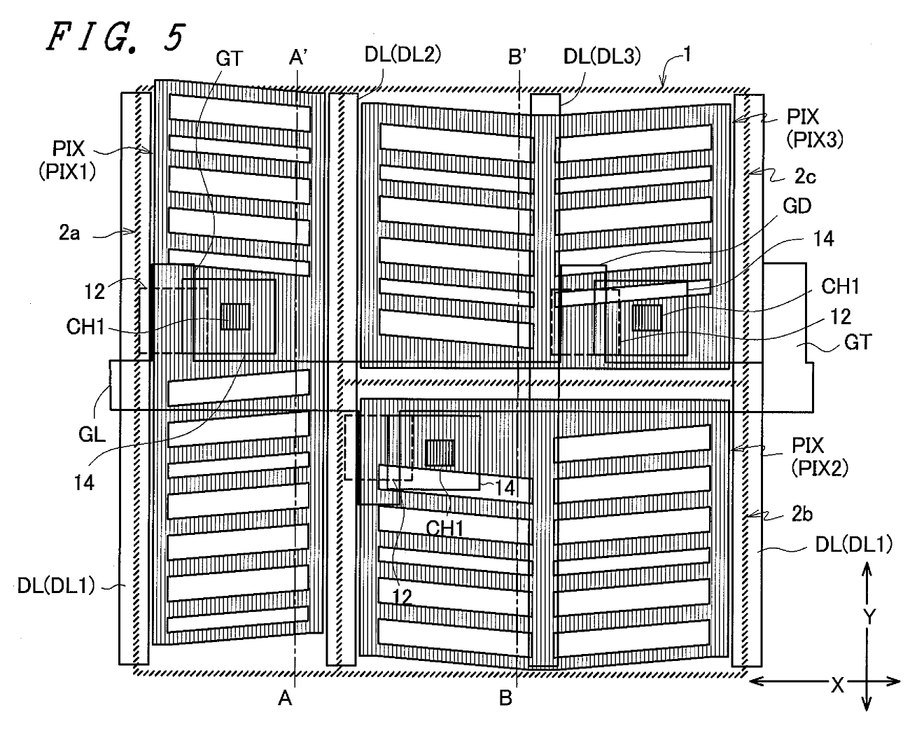

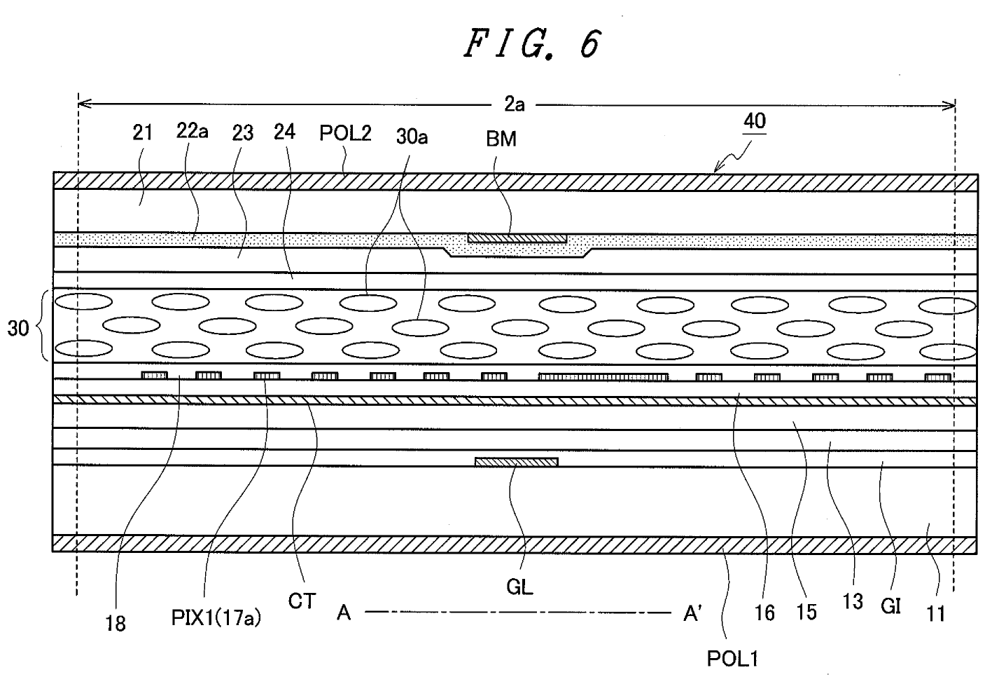

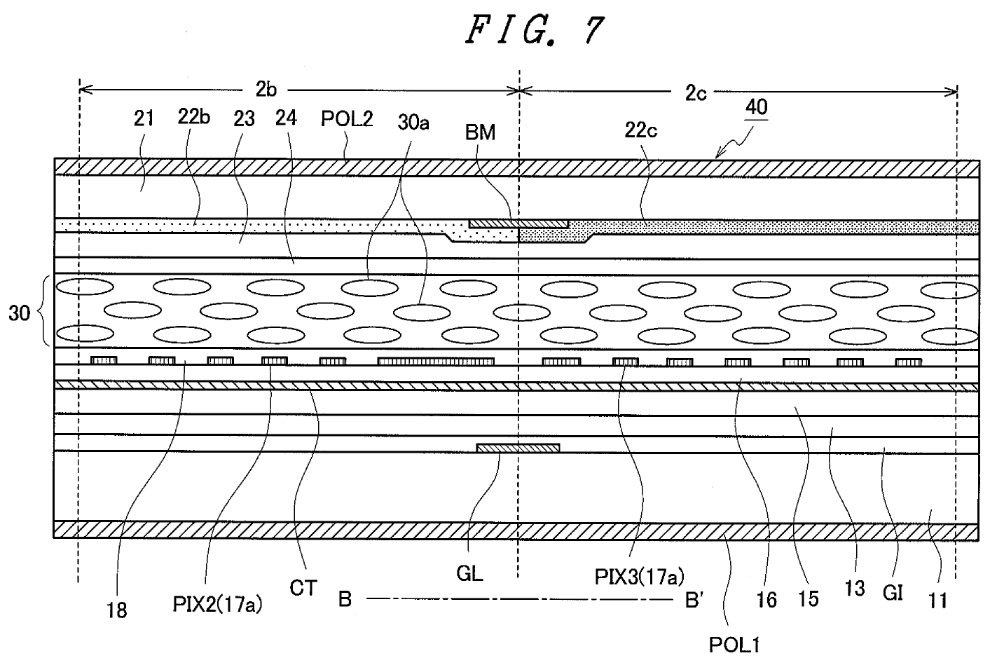

FIGS. 1 to 7 relate to the fully transmissive liquid crystal display device of the IPS type which is the first embodiment of the invention. FIG. 1 is a plan view showing an arrangement of color filters of a liquid crystal display panel. FIG. 2 is a partially enlarged plan view of FIG. 1. FIG. 3 is a plan view showing a configuration of pixels of FIG. 2 in a simplified manner. FIG. 4 is a plan view showing pixel electrodes and a counter electrode on a TFT substrate side of the liquid crystal display panel. FIG. 5 is a plan view showing the pixel electrodes, a scanning line, and video lines on the TFT substrate side of the liquid crystal display panel. FIG. 6 is a cross sectional view showing a cross sectional structure of the liquid crystal display panel taken along line A-A′ in FIG. 5. FIG. 7 is a cross sectional view showing a cross sectional structure of the liquid crystal display panel taken along line B-B′ in FIG. 5.

The fully transmissive liquid crystal display device of the IPS type of the first embodiment includes a liquid crystal display panel 40 shown in FIGS. 6 and 7.

As shown in FIGS. 6 and 7, the liquid crystal display panel 40 includes a liquid crystal layer 30 composed of numeral liquid crystal molecules 30a interposed between a pair of substrates (11 and 21), with a main surface side of the substrate 21 as a viewer side. As the substrates (11 and 21), for example, transparent insulating substrates such as of glass are used. For the liquid crystal layer 30, a positive liquid crystal or a negative liquid crystal is used.

The liquid crystal display panel 40 has a pixel array (display region) in which a plurality of pixels 1 shown in FIGS. 1 and 2 are arranged in a matrix. Each of the plurality of pixels 1 is composed of a first sub-pixel 2a for a first color, a second sub-pixel 2b for a second color, and a third sub-pixel 2c for a third color as shown in FIGS. 2 and 3. In the embodiment, for example, the first sub-pixel 2a for a first color is green (G), the second sub-pixel 2b for a second color is blue (B), and the third sub-pixel 2c for a third color is red (R).

Further, the liquid crystal display panel 40 has a scanning line GL extending along a first direction (in the embodiment, for example, an X-direction) and video lines DL crossing the scanning line GL and extending along a second direction (in the embodiment, for example, a Y-direction perpendicular to the X-direction) as viewed in a plane, as shown in FIG. 5. The scanning line GL is arranged in parallel in plural numbers in the Y-direction at a predetermined interval, while the video lines DL are arranged in parallel in plural numbers in the X-direction at a predetermined interval. The scanning line GL is arranged for each display line, while the video line DL is arranged (DL1, DL2, and DL3) corresponding to the three sub-pixels (2a, 2b, and 2c) constituting one pixel 1.

The plurality of pixels 1 arranged in one line along the X-direction constitute one display line, and the one display line is disposed in plural numbers in the Y-direction (scanning direction).

Here, a gap between two pixels 1 adjacent to each other and a gap between two sub-pixels adjacent to each other (2a/2b, 2a/2c, and 2b/2c) in the X-direction or the Y-direction are called pixel boundaries. The pixel boundaries define the plurality of pixels 1 and the plurality of sub-pixels individually.

In each of the pixels 1, each of the first sub-pixel 2a, the second sub-pixel 2b, and the third sub-pixel 2c has a pixel electrode PIX and a counter electrode CT (also referred to as common electrode) as shown in FIGS. 4 to 7, and further has any one of color filters of a color filter 22a for green (G), a color filter 22b for red (R), and a color filter 22c for blue (B). In the embodiment, for example, the first sub-pixel 2a has the color filter 22a for green, the second sub-pixel 2b has the color filter 22b for blue, and the third sub-pixel 2c has the color filter 22c for red.

As shown in FIGS. 6 and 7, on the liquid crystal layer 30 side of the substrate (also referred to as TFT substrate) 11, the scanning line GL, a gate insulating film GI, a semiconductor layer 12 made of amorphous silicon (refer to FIG. 5), an insulating film 13, the video line DL and an electrode 14 (refer to FIG. 5), an insulating film 15, the counter electrode CT, an insulating film 16, the pixel electrodes PIX (PIX1, PIX2, and PIX3), an orientation film 18, and the like are formed from the substrate 11 toward the liquid crystal layer 30 in this order. On the outer surface of the substrate 11 on the side opposite to the liquid crystal layer 30 side, a polarizer POL1 is arranged.

On the liquid crystal layer 30 side of the substrate (also referred to as CF substrate) 21, a light-shielding film (black matrix) BM, the color filters (22a, 22b, and 22c), a protection film 23, an orientation film 24, and the like are formed from the substrate 21 toward the liquid crystal layer 30 in this order. On the outer surface of the substrate 21 on the side opposite to the liquid crystal layer 30 side, a polarizer POL2 is arranged.

As shown in FIG. 5, the plurality of scanning lines GL cross the plurality of video lines DL via the insulating film. In the vicinity of each of crossing points where the scanning lines GL and the video lines DL cross each other, a thin film transistor (TFT) which is used as a switching element of each of the sub-pixels (2a, 2b, and 2c) is disposed. That is, each of the first sub-pixel 2a, the second sub-pixel 2b, and the third sub-pixel 2c has the thin film transistor. The On and OFF of the thin film transistor is controlled by a scanning signal (voltage) from the scanning line GL. A video signal (voltage) from the video line DL is supplied to the pixel electrode PIX via the thin film transistor.

The thin film transistor includes a gate electrode GT formed integrally with the scanning line GL, the gate insulating film GI formed so as to cover the gate electrode GT, and a pair of semiconductor regions formed in the semiconductor layer 12 made of amorphous silicon and functioning as a source region and a drain region. The semiconductor layer 12 is formed so as to cross the gate electrode GT via the gate insulating film GI. One of the pair of semiconductor regions is electrically connected with the video line DL, while the other is electrically connected with the electrode 14. The electrode 14 is formed in the same layer as the video line DL but electrically separated from the video line DL, and electrically connected with the pixel electrode PIX via a contact hole CH1 reaching from the surface of the insulating film 16 to the electrode 14.

As shown in FIG. 4, the pixel electrode PIX1 of the first sub-pixel 2a includes a plurality of first linear portions 17a, a plurality of second linear portions 17b, a second joined portion 17c, and a third joined portion 17c. The first linear portions 17a extend at an angle of +θ with respect to the extending direction of the video line DL (the Y-direction and scanning direction) and are arranged in parallel in the extending direction of the video line DL at a predetermined interval. The second linear portions 17b extend at an angle of −θ with respect to the extending direction of the video line DL and are arranged in parallel in the extending direction of the video line DL at a predetermined interval. The second joined portion 17c extends along the extending direction of the video line DL and is joined to one end side of each of the plurality of first and second linear portions (17a and 17b). The third joined portion 17c extends along the extending direction of the video line DL and is joined to the other end side of each of the plurality of first and second linear portions (17a and 17b).

Each of the pixel electrodes (PIX2 and PIX3) of the second sub-pixel 2b and the third sub-pixel 2c includes a first joined portion 17c, the plurality of first linear portions 17a, the plurality of second linear portions 17b, the second joined portion 17c, and the third joined portion 17c. The first joined portion 17c extends along the extending direction of the video line DL (the Y-direction and scanning direction). The first linear portions 17a protrude from the first joined portion 17c, extend at an angle of +θ with respect to the extending direction of the video line DL (the Y-direction and scanning direction), and are arranged in parallel in the extending direction of the video line DL at a predetermined interval. The second linear portions 17b protrude from the first joined portion 17c to the side opposite to the first linear portions 17a, extend at an angle of −θwith respect to the extending direction of the video line DL (the Y-direction and scanning direction), and are arranged in parallel in the extending direction of the video line DL at a predetermined interval. The second joined portion 17c extends along the extending direction of the video line DL and is joined to the other end side of each of the plurality of first linear portions 17a. The third joined portion 17c extends along the extending direction of the video line DL and is joined to the other end side of each of the plurality of second linear portions 17b.

That is, the respective pixel electrodes PIX (PIX1, PIX2, and PIX3) of the first sub-pixel 2a, the second sub-pixel 2b, and the third sub-pixel 2c of the embodiment have a multi-domain structure with the plurality of first linear portions 17a extending at an angle of +θ with respect to the extending direction of the video line DL (the Y-direction and scanning direction) and arranged in parallel in the extending direction of the video line DL at a predetermined interval, and the plurality of second linear portions 17b extending at an angle of −θ with respect to the extending direction of the video line DL and arranged in parallel in the extending direction of the video line DL at a predetermined interval.

Here, θ is desirably from 70° to 87°.

The counter electrode CT is formed in a planar shape. As shown in FIGS. 6 and 7, the counter electrode CT and the pixel electrodes (PIX1, PIX2, and PIX3) are stacked together via the insulating film 16, whereby a holding capacitance is formed. In the embodiment, the pixel electrodes (PIX1, PIX2, and PIX3) are formed on an upper layer than the counter electrode CT. The counter electrode CT and the pixel electrode PIX are formed of a transparent conductive film such as of ITO (Indium Tin Oxide), for example.

In FIGS. 6 and 7, although not shown, a backlight is arranged outside the polarizer POL1 on the substrate 11 side. Therefore, the liquid crystal display device functions as a transmissive liquid crystal display device with the main surface side of the substrate 21 as a viewer side.

In the fully transmissive liquid crystal display device of the IPS type of the embodiment, an electric field is caused by the pixel electrode PIX and the counter electrode CT, whereby the liquid crystal molecules 30a of the liquid crystal layer 30 can be reoriented in plane. Since the phase difference of the liquid crystal layer 30 changes depending on the magnitude of the electric field, a linearly polarized light having passed through the polarizer POL1 on the substrate 11 side is changed in phase with the liquid crystal layer 30, whereby it is possible to select whether the light should “pass through” or “not pass through” the polarizer POL2 on the opposite side. As a result, the contrast of light can be displayed on the viewer side.

The fully transmissive liquid crystal display device of the IPS type of the embodiment has a normally black characteristic and employs a frame inversion driving method as an AC driving method.

The configuration and arrangement of the pixels 1 and the arrangement of the light-shielding film BM will be described with reference to FIGS. 2 and 3.

Each of the plurality of pixels 1 is composed of the first sub-pixel 2a, the second sub-pixel 2b, and the third sub-pixel 2c.

Each of the first to third sub-pixels (2a, 2b, and 2c) is formed in a rectangular plane shape with long sides and short sides. The longitudinal direction of the first sub-pixel 2a is the extending direction of the video line DL (the Y-direction and scanning direction), while the longitudinal direction of each of the second and third sub-pixels (2b and 2c) is the extending direction of the scanning line GL (the X-direction and one display line direction).

The second sub-pixel 2b and the third sub-pixel 2c are arranged adjacent to each other in the extending direction of the video line DL (the Y-direction and scanning direction) on one side of the first sub-pixel 2a.

In two adjacent pixels 1 (for example, 1a/1b and 1b/1c) in the extending direction of the video line DL (the Y-direction and scanning direction), the first sub-pixels 2a are continuously formed.

When three adjacent pixels 1 in the extending direction of the video line DL (the Y-direction and scanning direction) are defined as the first to third pixels (1a, 1b, and 1c), the second sub-pixels 2b are continuously formed in the first pixel 1a and the second pixel 1b, and the third sub-pixels 2c are continuously formed in the second pixel 1b and the third pixel 1c.

That is, in the two adjacent pixels 1 in the extending direction of the video line DL, the respective first sub-pixels 2a of the same color (green in the embodiment) are adjacent to each other. Further, when the three adjacent pixels 1 in the extending direction of the video line DL (the Y-direction and scanning direction) are defined as the first to third pixels (1a, 1b, and 1c), the respective second sub-pixels 2b of the same color (blue in the embodiment) are adjacent to each other in the first pixel 1a and the second pixel 1b, and the respective third sub-pixels 2c of the same color (red in the embodiment) are adjacent to each other in the second pixel 1b and the third pixel 1c.

The color filter 22a is common to the respective first sub-pixels 2a of two adjacent pixels 1 in the extending direction of the video line DL (the Y-direction and scanning direction) When three adjacent pixels 1 in the extending direction of the video line DL (the Y-direction and scanning direction) are defined as the first to third pixels (1a, 1b, and 1c), the color filter 22b is common to the respective second sub-pixels 2b of the first pixel 1a and the second pixel 1b, and the color filter 22c is common to the respective third sub-pixels 2c of the second pixel 1b and the third pixel 1c.

When two adjacent pixels 1 in the extending direction of the scanning line GL (the X-direction and one display line direction) are respectively defined as one pixel and the other pixel, the second sub-pixel 2b and the third sub-pixel 2c are arranged adjacent to each other in the extending direction of the video line DL (the Y-direction and scanning direction) on one side of the first sub-pixel 2a in the order of the second sub-pixel 2b and the third sub-pixel 2c in the one pixel 1. In the other pixel 1, the second sub-pixel 2b and the third sub-pixel 2c are arranged adjacent to each other in the extending direction of the video line DL on one side of the first sub-pixel 2a in the order of the third sub-pixel 2c and the second sub-pixel 2b.

In the embodiment, as shown in FIG. 5, the video line DL1 is arranged at a position where it overlaps the pixel boundary between two adjacent pixels 1 in the extending direction of the scanning line GL in a plane. The video line DL2 is arranged at a position where it overlaps the pixel boundary between the first sub-pixel 2a and the second and third sub-pixels (2b and 2c) in a plane. The video line DL3 is arranged at a position where it crosses the center portions of the second and third sub-pixels (2b and 2c).

The light-shielding film BM is formed so as to overlap (superimpose) the pixel boundary between two adjacent pixels 1 in the extending direction of the scanning line GL (the X-direction and one display line direction) in a plane, except for the pixel boundary between two adjacent pixels 1 in the extending direction of the video line DL (the Y-direction and scanning direction). Further, the light-shielding film BM is formed so as to overlap (superimpose) the pixel boundary between the first sub-pixel 2a and the second and third sub-pixels (2b and 2c) in a plane in each of the pixels 1. Still further, the light-shielding film BM is formed so as to overlap (superimpose) the pixel boundary between the second sub-pixel 2b and the third sub-pixel 2c in a plane in each of the pixels 1. In the embodiment, the light-shielding film BM between the second sub-pixel 2b and the third sub-pixel 2c is formed so as to cross the first sub-pixel 2a.

That is, the light-shielding film BM is not formed in the pixel boundary between two adjacent pixels 1 in the extending direction of the video line DL (the Y-direction and scanning direction).

In a liquid crystal display device, the light-shielding film BM such as a black matrix is usually disposed between sub-pixels different in color in order to avoid color mixture. In the case where two adjacent sub-pixels have the same color, the light-shielding film BM does not need to be formed between the two sub-pixels because color mixture cannot occur. When the light-shielding film BM is no more necessary, the aperture ratio can be improved.

In the embodiment, in two adjacent pixels 1 in the extending direction of the video line DL, the respective first sub-pixels 2a of the same color (green in the embodiment) are adjacent to each other. When three adjacent pixels 1 in the extending direction of the video line DL (the Y-direction and scanning direction) are defined as the first to third pixels (1a, 1b, and 1c), the respective second sub-pixels 2b of the same color (blue in the embodiment) are adjacent to each other in the first pixel 1a and the second pixel 1b, and the respective third sub-pixels 2c of the same color (red in the embodiment) are adjacent to each other in the second pixel 1b and the third pixel 1c. Therefore, in the two adjacent pixels 1 (1a/1b and 1b/1c) in the extending direction of the video line DL, the light-shielding film BM does not need to be formed between the two sub-pixels (2a/2a, 2b/2b, and 2c/2c), whereby the aperture ratio can be improved.

The transmittance of the liquid crystal display panel 40 improves as the aperture ratio improves. When the luminance of a backlight is constant, display luminance is improved by improving the aperture ratio, providing an advantage that display quality is improved. Further, in order to provide the same display luminance, the luminance of a backlight is decreased by improving the aperture ratio, leading to a decrease in power consumption of a backlight.

### Second Embodiment

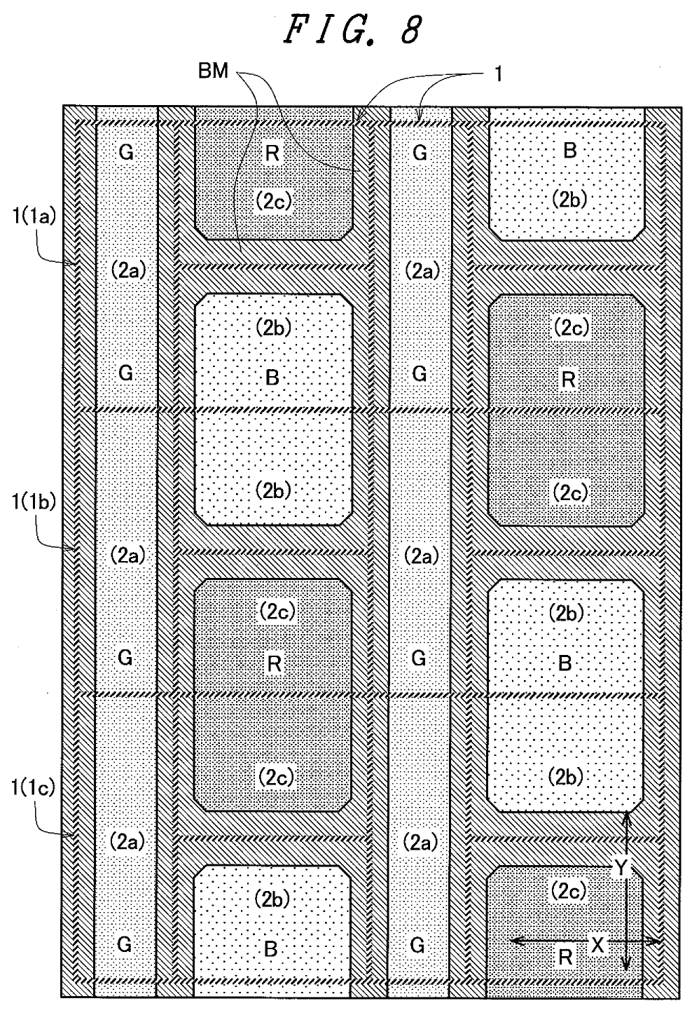

FIG. 8 is a plan view showing an arrangement of color filters of a liquid crystal display panel in a fully transmissive liquid crystal display device of the IPS type of a second embodiment of the invention. FIG. 8 corresponds to FIG. 2 of the first embodiment.

The fully transmissive liquid crystal display device of the IPS type of the second embodiment has basically a similar configuration to that of the first embodiment but is different in the following point.

That is, as shown in FIG. 2, the light-shielding film BM between the second sub-pixel 2b and the third sub-pixel 2c is formed so as to cross the first sub-pixel 2a in the first embodiment. In the second embodiment, however, as shown in FIG. 8, the light-shielding film BM between the second sub-pixel 2b and the third sub-pixel 2c does not cross the first sub-pixel 2a but terminates in the second sub-pixel 2b and the third sub-pixel 2c.

In the thus configured second embodiment, the aperture ratio can be further improved.

### Third Embodiment

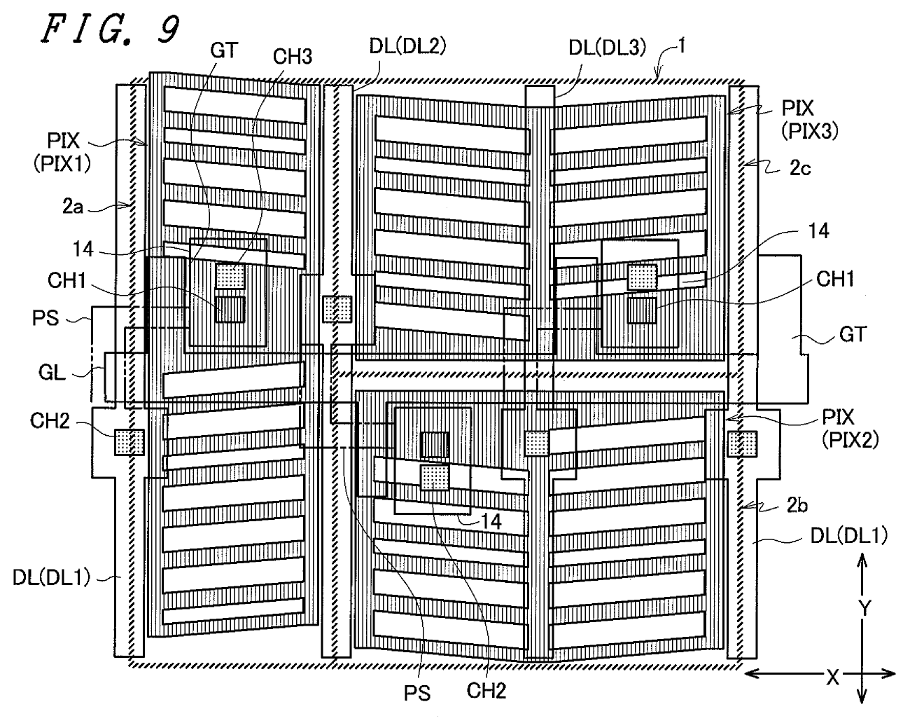

FIG. 9 is a plan view showing pixel electrodes, a scanning line, and video lines on a TFT substrate side of a liquid crystal display panel in a fully transmissive liquid crystal display device of the IPS type of a third embodiment of the invention.

The fully transmissive liquid crystal display device of the IPS type of the third embodiment has basically a similar configuration to that of the first embodiment but is different in the following point.

That is, a thin film transistor used as a switching element of each of the sub-pixels (2a, 2b, and 2c) is different. In the thin film transistor of the first embodiment, the pair of semiconductor regions functioning as a source region and a drain region are formed in the semiconductor layer 12 made of amorphous silicon. In the thin film transistor of the third embodiment, however, the pair of semiconductor regions functioning as a source region and a drain region are formed in a semiconductor layer PS made of polysilicon (refer to FIG. 9).

The thin film transistor of the third embodiment includes the pair of semiconductor regions functioning as a source region and a drain region formed in the semiconductor layer PS made of polysilicon, the gate insulating film (GI) formed so as to cover the semiconductor layer PS, and the gate electrode GT formed integrally with the scanning line GL on the semiconductor layer PS via the gate insulating film.

One of the pair of semiconductor regions functioning as a source region and a drain region is electrically connected with the video line DL via a contact hole CH2 reaching from the video line DL to the semiconductor layer PS, while the other is electrically connected with the electrode 14 via a contact hole CH3 reaching from the electrode 14 to the semiconductor layer PS. The electrode 14 is formed on the same layer as the video line DL but electrically separated from the video line DL, and electrically connected with the pixel electrode PIX via the contact hole CH1 reaching from the pixel electrode PIX to the electrode 14.

Also in the thus configured fully transmissive liquid crystal display device of the IPS type of the third embodiment, the aperture ratio can be improved in the same manner as in the first and second embodiments.

### Fourth Embodiment

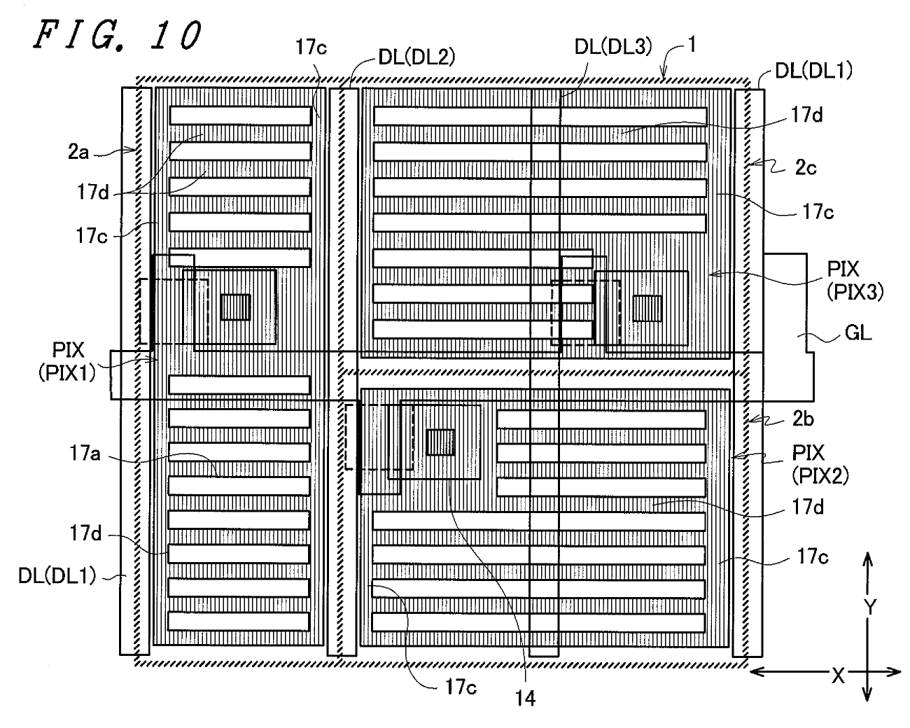

FIG. 10 is a plan view showing pixel electrodes, a scanning line, and video lines on a TFT substrate side of a liquid crystal display panel in a fully transmissive liquid crystal display device of the IPS type of a fourth embodiment of the invention.

The fully transmissive liquid crystal display device of the IPS type of the fourth embodiment has basically a similar configuration to that of the first embodiment but is different in the following point.

That is, although the pixel electrodes PIX (PIX1, PIX2, and PIX3) of the first embodiment have the multi-domain structure as shown in FIG. 4, the pixel electrodes PIX (PIX1, PIX2, and PIX3) of the fourth embodiment have a single-domain structure as shown in FIG. 10.

The pixel electrodes PIX (PIX1, PIX2, and PIX3) of the single-domain structure each include a plurality of linear portions 17d, the second joined portion 17c, and the third joined portion 17c. The plurality of linear portions 17d extend along the extending direction of the scanning line GL (the X-direction and one display line direction) and are arranged in parallel in the extending direction of the video line DL (the Y-direction and scanning direction) at a predetermined interval. The second joined portion 17c extends along the extending direction of the video line DL and is joined at one end side of each of the plurality of linear portions 17d. The third joined portion 17c extends along the extending direction of the video line DL and is joined to the other end side of each of the plurality of linear portions 17d.

In the thus configured fourth embodiment, the aperture ratio can be improved in the same manner as in the first and second embodiments.

### Fifth Embodiment

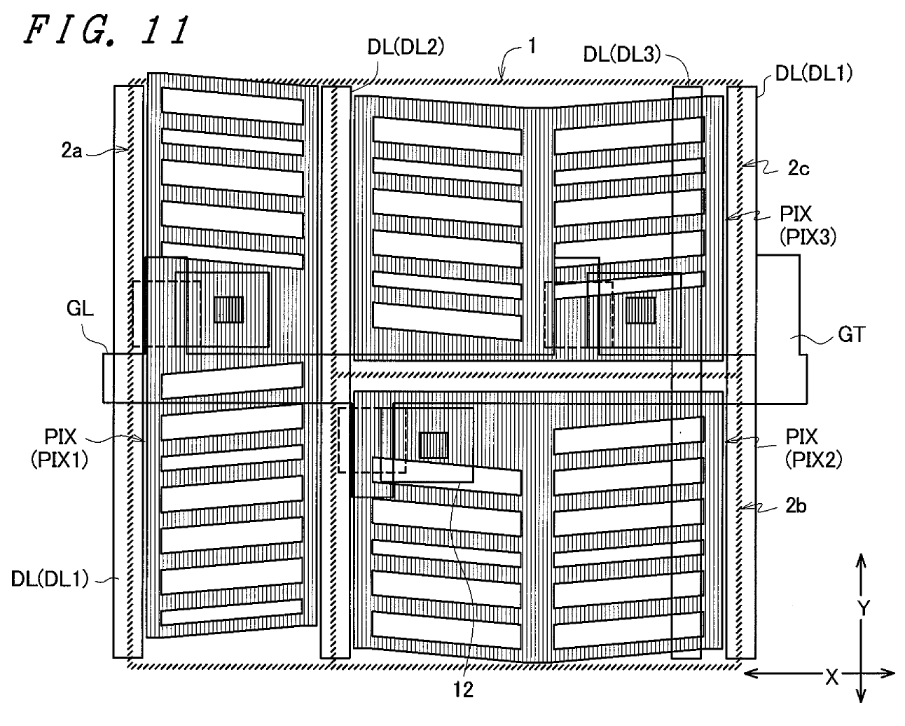

FIG. 11 is a plan view showing pixel electrodes, a scanning line, and video lines on a TFT substrate side of a liquid crystal display panel in a fully transmissive liquid crystal display device of the IPS type of a fifth embodiment of the invention.

The fully transmissive liquid crystal display device of the IPS type of the fifth embodiment has basically a similar configuration to that of the first embodiment but is different in the following point.

That is, in the first embodiment, as shown in FIG. 5, the video line DL3 electrically connected with the thin film transistor of the second sub-pixel 2b is formed at a position where it crosses the center portions of the second and third sub-pixels (2b and 2c). In the fifth embodiment, however, as shown in FIG. 11, when two adjacent pixels 1 in the extending direction of the scanning line GL are respectively defined as one pixel 1 and the other pixel 1, the video line DL3 electrically connected with the thin film transistor of the third sub-pixel 2c in the one pixel 1 and the video line DL1 electrically connected with the thin film transistor of the first sub-pixel 2a in the other pixel 1 are arranged close to each other.

In the thus configured fifth embodiment, the aperture ratio can be improved in the same manner as in the first and second embodiments.

### Sixth Embodiment

The first to fifth embodiments have described the examples in which the invention is applied to the fully transmissive liquid crystal display device of the IPS type which is one of display devices. However, a sixth embodiment will describe an example in which the invention is applied to an organic electroluminescent display device which is another display device.

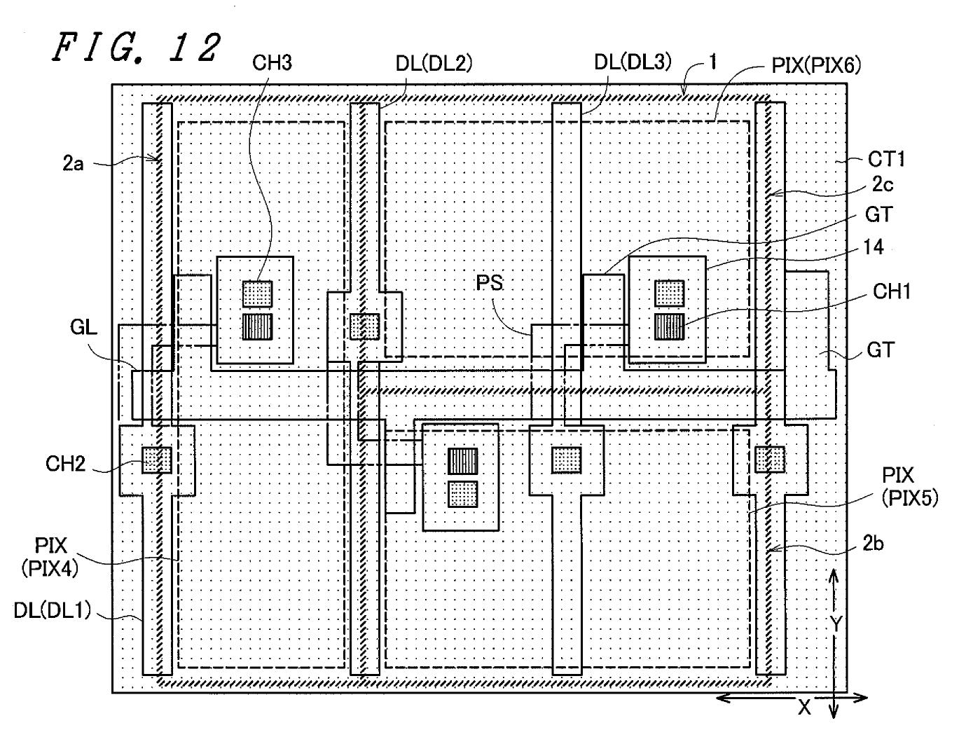

FIG. 12 is a plan view showing electrodes and wiring in one pixel in the organic electroluminescent display device of the sixth embodiment of the invention.

The organic electroluminescent display device of the sixth embodiment has the plurality of pixels 1 arranged in a matrix. Similarly to the first to fifth embodiments, each of the plurality of pixels 1 includes the first sub-pixel 2a for a first color, the second sub-pixel 2b for a second color, and the third sub-pixel 2c for a third color.

Each of the first to third sub-pixels (2a, 2b, and 2c) is formed in a rectangular plane shape with long sides and short sides. The longitudinal direction of the first sub-pixel 2a is the extending direction of the video line DL (the Y-direction and scanning direction), while the longitudinal direction of each of the second and third sub-pixels (2b and 2c) is the extending direction of the scanning line GL (the X-direction and one display line direction).

The second sub-pixel 2b and the third sub-pixel 2c are arranged adjacent to each other in the extending direction of the video line DL (the Y-direction and scanning direction) on one side of the first sub-pixel 2a.

In two adjacent pixels 1 (for example, 1a/1b and 1b/1c) in the extending direction of the video line DL (the Y-direction and scanning direction), the first sub-pixels 2a are continuously formed.

When three adjacent pixels 1 in the extending direction of the video line DL (the Y-direction and scanning direction) are defined as the first to third pixels (1a, 1b, and 1c), the second sub-pixels 2b are continuously formed in the first pixel 1a and the second pixel 1b, and the third sub-pixels 2c are continuously formed in the second pixel 1b and the third pixel 1c.

That is, also in the sixth embodiment, in two adjacent pixels 1 in the extending direction of the video line DL, the respective first sub-pixels 2a of the same color (green in the embodiment) are adjacent to each other. Further, when three adjacent pixels 1 in the extending direction of the video line DL (the Y-direction and scanning direction) are defined as the first to third pixels (1a, 1b, and 1c), the respective second sub-pixels 2b of the same color (blue in the embodiment) are adjacent to each other in the first pixel 1a and the second pixel 1b, and the respective third sub-pixels 2c of the same color (red in the embodiment) are adjacent to each other in the second pixel 1b and the third pixel 1c.

Unlike the pixels 1 in the first to fifth embodiments, each of the plurality of pixels 1 of the embodiment has an OLED (Organic Light-Emitting Diode) structure in which a light-emitting material layer is interposed between the pixel electrodes PIX (first electrode: PIX4, PIX5, and PIX6) and the common electrode CT1 (second electrode). The light-emitting material layer emits light according to the magnitude of current flowing through the light-emitting material layer between the pixel electrodes PIX and the common electrode CT1. The pixel electrodes PIX are formed to be separated from one another for each pixel, while the common electrode CT1 is common to the pixels.

In the organic electroluminescent display device, an insulating film called a bank film is disposed between two adjacent sub-pixels. The bank film is provided with a plurality of openings to expose a pixel electrode of each pixel.

Also in the organic electroluminescent display device, the light-shielding film BM such as a black matrix may be disposed between sub-pixels different in color in order to avoid color mixture. In the case where two adjacent sub-pixels have the same color, the light-shielding film BM does not need to be formed between the two sub-pixels because color mixture cannot occur. When the light-shielding film BM is no more necessary, the aperture ratio can be improved.

Accordingly also in the sixth embodiment, similarly to the first to fifth embodiments, in two adjacent pixels 1 in the extending direction of the video line DL, the respective first sub-pixels 2a of the same color (green in the embodiment) are adjacent to each other. When three adjacent pixels 1 in the extending direction of the video line DL (the Y-direction and scanning direction) are defined as the first to third pixels (1a, 1b, and 1c), the respective second sub-pixels 2b of the same color (blue in the embodiment) are adjacent to each other in the first pixel 1a and the second pixel 1b, and the respective third sub-pixels 2c of the same color (red in the embodiment) are adjacent to each other in the second pixel 1b and the third pixel 1c. Therefore, in the two adjacent pixels 1 (1a/1b and 1b/1c) in the extending direction of the video line DL, the light-shielding film BM does not need to be formed between the two sub-pixels (2a/2a, 2b/2b, and 2c/2c), whereby the aperture ratio can be improved.

Although the first embodiment has described the pixel structure in which the pixel electrode PIX is stacked on the counter electrode CT via the insulating film, the invention can be applied to a pixel structure in which the counter electrode is stacked on the pixel electrode PIX via the insulating film.

Further, although the first to fifth embodiments have described the examples in which the invention is applied to the fully transmissive liquid crystal display device of the IPS type, the invention can be applied to a semitransmissive liquid crystal display device of the IPS type, a fully transmissive or semitransmissive liquid crystal display device of a vertical electric field type.

Although the sixth embodiment has described the example in which the invention is applied to the organic electroluminescent display device, the invention can be applied to other type display device such as an inorganic electroluminescent display device.

Although the invention made by the inventor has been specifically described so far based on the embodiments, it is apparent that the invention is not limited to the embodiments and can be modified variously within a range not departing from the gist thereof.

What is claimed is:

1. A display device comprising:
a plurality of pixels arranged in a matrix;
a plurality of scanning lines extending in a first direction and arranged in parallel in a second direction crossing the first direction; and
a plurality of video lines extending in the second direction while crossing the scanning lines and arranged in parallel in the first direction, wherein
each of the plurality of pixels is composed of a first sub-pixel for a first color, a second sub-pixel for a second color, and a third sub-pixel for a third color,
the longitudinal direction of the first sub-pixel is the extending direction of the video lines,
the longitudinal direction of each of the second sub-pixel and the third sub-pixel is the extending direction of the scanning lines,
the second sub-pixel and the third sub-pixel are arranged adjacent to each other in the extending direction of the video lines on one side of the first sub-pixel,
the first sub-pixels are continuously formed in two adjacent pixels in the extending direction of the video lines, and
when three adjacent pixels in the extending direction of the video lines are defined as first to third pixels, the second sub-pixels are continuously formed in the first pixel and the second pixel, and the third sub-pixels are continuously formed in the second pixel and the third pixel.

2. The display device according to claim 1, further comprising a light-shielding area between the second sub-pixel and the third sub-pixel.

3. The display device according to claim 2, wherein the light-shielding area is formed so as to cross the first sub-pixel.

4. The display device according to claim 1, wherein when two adjacent pixels in the extending direction of the scanning lines are respectively defined as one pixel and the other pixel, the second sub-pixel and the third sub-pixel are arranged adjacent to each other in the extending direction of the video lines on one side of the first sub-pixel in the order of the second sub-pixel and the third sub-pixel in said one pixel, and
the second sub-pixel and the third sub-pixel are arranged adjacent to each other in the extending direction of the video lines on one side of the first sub-pixel in the order of the third sub-pixel and the second sub-pixel in the other pixel.

5. The display device according to claim 1, wherein a video line for any one of the second sub-pixel and the third sub-pixel and a video line for the first sub-pixel among the plurality of video lines are arranged close to each other.

6. The display device according to claim 1, which is a liquid crystal display device including a liquid crystal display panel having
the plurality of pixels,
the plurality of scanning lines, and
the plurality of video lines.

7. The display device according to claim 6, wherein the liquid crystal display device has a normally black characteristic.

8. The display device according to claim 6, wherein the liquid crystal display device is a liquid crystal display device of a vertical electric field type.

9. The display device according to claim 6, wherein the liquid crystal display device is a liquid crystal display device of a lateral electric field type.

10. A liquid crystal display device comprising:
a liquid crystal display panel having a first substrate, a second substrate, and a liquid crystal layer interposed between the first substrate and the second substrate,
the liquid crystal display panel having a plurality of pixels arranged in a matrix, a plurality of scanning lines extending in a first direction and arranged in parallel in a second direction crossing the first direction, and a plurality of video lines extending in the second direction while crossing the scanning lines and arranged in parallel in the first direction, wherein
each of the plurality of pixels is composed of a first sub-pixel having a color filter for a first color, a second sub-pixel having a color filter for a second color, and a third sub-pixel having a color filter for a third color,
each of the first sub-pixel, the second sub-pixel, and the third sub-pixel has a pixel electrode formed above the first substrate and a counter electrode formed above the first substrate,
the longitudinal direction of the first sub-pixel is the extending direction of the video lines,
the longitudinal direction of each of the second sub-pixel and the third sub-pixel is the extending direction of the scanning lines,
the second sub-pixel and the third sub-pixel are arranged adjacent to each other in the extending direction of the video lines on one side of the first sub-pixel,
the first sub-pixels are continuously formed in two adjacent pixels in the extending direction of the video lines, and
when three adjacent pixels in the extending direction of the video lines are defined as first to third pixels, the second sub-pixels are continuously formed in the first pixel and the second pixel, and the third sub-pixels are continuously formed in the second pixel and the third pixel.

11. The liquid crystal display device according to claim 10, wherein each of the pixel electrodes of the first sub-pixel, the second sub-pixel, and the third sub-pixel has a plurality of linear portions extending along the extending direction of the scanning lines and arranged in parallel in the extending direction of the video lines.

12. The liquid crystal display device according to claim 10, wherein each of the pixel electrodes of the first sub-pixel, the second sub-pixel, and the third sub-pixel has a plurality of first linear portions extending at an angle of θ with respect to the video lines and arranged in parallel in the extending direction of the video lines, and
a plurality of second linear portions extending at an angle of −θ with respect to the video lines and arranged in parallel in the extending direction of the video lines.

13. The liquid crystal display device according to claim 10, wherein an AC driving method of the liquid crystal display device is a frame inversion driving method.

14. The liquid crystal display device according to claim 10, further comprising a light-shielding film between the second sub-pixel and the third sub-pixel.

15. The liquid crystal display device according to claim 14, wherein the light-shielding film is formed so as to cross the first sub-pixel.

16. The liquid crystal display device according to claim 10, wherein when two adjacent pixels in the extending direction of the scanning lines are respectively defined as one pixel and the other pixel, the second sub-pixel and the third sub-pixel are arranged adjacent to each other in the extending direction of the video lines on one side of the first sub-pixel in the order of the second sub-pixel and the third sub-pixel in said one pixel, and
the second sub-pixel and the third sub-pixel are arranged adjacent to each other in the extending direction of the video lines on one side of the first sub-pixel in the order of the third sub-pixel and the second sub-pixel in the other pixel.

17. The liquid crystal display device according to claim 10, wherein the pixel electrode and the counter electrode are stacked together via an insulating film.
